(19) United States
(12) Patent Application Publication
(10) Pub. No.: US 2021/0120374 A1
(43) Pub. Date: Apr. 22, 2021

(54) Many to Many Text Messaging System and Related Methods

(71) Applicant: Eric Hayes, Los Angeles, CA (US)

(72) Inventor: Eric Hayes, Los Angeles, CA (US)

(21) Appl. No.: 17/077,645

(22) Filed: Oct. 22, 2020

Related U.S. Application Data
(60) Provisional application No. 62/924,630, filed on Oct. 22, 2019.

(51) Int. Cl. H04W 4/06; H04L 12/58; H04W 4/14

(52) U.S. Cl. CPC H04W 4/06; H04L 51/38; H04W 4/14; H04L 51/14; H04L 51/04

(57) ABSTRACT

Methods and apparatuses sending mass text messages are disclosed herein. In one method, a system assigs a unique hashtag and dynamically assigned phone number in response to a user activating a dynamic URL. The system receives a pre-generated text message sent from the user device. The system places the user within a pool of users capable of receiving a mass text message. The system sends the mass text message to the pool of users based on the dynamically assigned phone number.

### CROSS-REFERENCE TO RELATED APPLICATIONS

The present application claims the benefit of U.S. Provisional Patent Application Ser. No. 62/924,630 filed on Oct. 22, 2019, the entire disclosure of which is incorporated herein in its entirety by reference.

### FIELD

The subject matter disclosed herein generally relates to methods and systems for sending mass text messages.

### BACKGROUND

Currently, sending a mass long code text message blast is technologically limited as only one message/second may be sent by a user/operator. Accordingly, individuals or organizations cannot send a simultaneous, mass text message to its customers/followers. Rather, it will take some time and multiple groups of text messages to send a mass text message to a large number of recipients.

### SUMMARY

Methods and systems for sending mass text messages are disclosed herein. In one method, a system assigs a unique hashtag and dynamically assigned phone number in response to a user activating a dynamic URL. The system receives a pre-generated text message sent from the user device. The system places the user within a pool of users capable of receiving a mass text message. The system sends the mass text message to the pool of users based on the dynamically assigned phone number.

In another method, the system receives information about a user device information when a user activates a dynamic URL on a website. The system determines a type of the user device based on the information received from the user device. The system generates a pre-generated text message on the user device when the user device is a mobile phone. The system assigns a unique hashtag and dynamically assigned phone number to the pre-generated text message. The system receives the pre-generated text message sent from the user device. The system places the user within a pool of users capable of receiving a mass text message. The system sends the mass text message to the pool of users based on the dynamically assigned phone number.

In another aspect, a system for sending mass text messages includes a processor; and a memory coupled to the processor. The processor is configured to execute a program code stored in the memory to: assign a unique hashtag and dynamically assigned phone number in response to a user activating a dynamic URL; receive a pre-generated text message sent from the user device; place the user within a pool of users capable of receiving a mass text message; select a pool of users to receive a mass text message; and send the mass text message to the pool of users based on the dynamically assigned phone number.

### BRIEF DESCRIPTION OF DRAWINGS

FIG. 1 is a flow diagram for one exemplary embodiment from the perspective of the system.

FIG. 2 is a flow diagram for one exemplary embodiment from the perspective of the system.

FIG. 3 is a flow diagram for one exemplary embodiment from the perspective of the user.

### DETAILED DESCRIPTION

Briefly, and in general terms, various systems and related methods are directed to allowing the rapid dissemination of text messages. According to various embodiments, when a recipient decides to opt-in to text messaging from an organization (or individual), the recipient's opt-in message is assigned to a 10-digit telephone number and this number is also assigned to the organization. When the organization decides to send a message or content such as a video, the system will receive the message/content from the individual/organization and, in turn, it will attach the message/content to all of its assigned phone numbers and disseminate the message/content to its intended recipients. The system has access a pool of phone numbers will allows the system to scale-up based on the number of recipients responding to a particular message.

For the perspective of an operator, according to one method, a dynamic internet URL is provided to customers on a website. In one embodiment, the dynamic internet URL is a link via web browser. Alternatively, the dynamic URL is a QR code that may be scanned with the customer's computing device. When the customer activates the dynamic URL link, the system receives information about the type of computing device (e.g., mobile phone, smartphone, tablet, or PC) used by the customer. According to one method, the system analyzes the request headers automatically sent from the user's device browser when it requests the URL from the system.

Once the system determines the customer's device type, the system creates and presents a pre-generated text message on the customer's device. The pre-generated text message is an opt-in and/or subscription text message from the customer. In some embodiments, the pre-generated text message also includes the customer's express consent to receive messages and other information upon the customer's opt-in.

The system assigns the pre-generated text message to a dynamically assigned phone number. The system also assigns a unique hashtag to the pre-generated text message. The customer may then send the pre-generated text message to the operator. Once the system receives the pre-generated text message from the customer, the system associates, via the unique hashtag, the customer's phone number—in the case of a mobile phone—with the dynamically assigned phone number for all future communications. If the URL is accessed from a PC or a computing device that is not associated with a phone number, the system initiates an email instead of a text message. The email is used for all future communications for that device. The dynamically assigned phone numbers allow a single operator to communicate with a large number (for example, but not limited to, thousands) of customers instantly as the operator may send text messages to each customer who is assigned to a unique number.

When the operator desires to send a mass text message to a pool of recipients, the system allows the operator to create a text message and select all the recipients who will receive the text message. The system automatically generates certain sets of recipients as recipients' groups, including an ‘All Recipients’ group, and also allows the operator to create custom groups, any of which can be selected by the operator as the target group for a text message. In one embodiment, the system provides the operator with numerous criteria to create such customer groups. The criteria may include, but is not limited to, dynamic URLs, geographical location, area code, user's gender, or any other information provided by the user. Once the operator selects the recipients of the text message, the operator presses ‘Send’ button on the operator interface, and the system routes the text message over the previously assigned number for each recipient (or via email for those users not on a mobile phone device) without further input from the operator.

In another aspect of the disclosed system, different operators can reuse those same numbers for different customers/followers. For example, if the system has 3 operators (A,B,C), 3 overlapping customers/followers (X,Y,Z) and 3 available phone numbers (1,2,3), then operator A, customer X would communicate via number 1, Y via number 2, and Z via number 3. And for operator B, customer X would communicate via number 3, customer Y via number 1, and customer Z via number 2. And for operator C, customer X would communicate via number 2, customer Y via number 3, and customer Z via number 1. There is theoretically no limit to the number of times the same number can be used—it is simply a matter of the number of operators and recipients.

Once all the dynamically assigned numbers are utilized, the system dynamically requisitions and provisions additional numbers as needed. Referring to the above example, after numbers 1, 2, and 3 are assigned by the organization, the system requisitions and provisions another number that may be used. As the number of customers/followers grow, more numbers are requisitioned and provisioned, essentially without limit.

From the customer's perspective, the customer receives and/or discovers a dynamic internet URL on a particular webpage. The customer clicks on the hyperlink, enters the URL into a web browser, or scans a QR code containing the URL. In response, the customer's device starts its text messaging application, and a pre-generated text message appears on the customer's device with an available SMS number in the “To field” of the text message. The customer agrees to the text message and sends the pre-generated text to the operator. The customer will then be subscribed to receive messages from the operator and said SMS number will henceforth be assigned to them for communications with this operator. The text messages may be an alphanumeric message, images, videos, gif files, links to videos or URL links to other internet content.

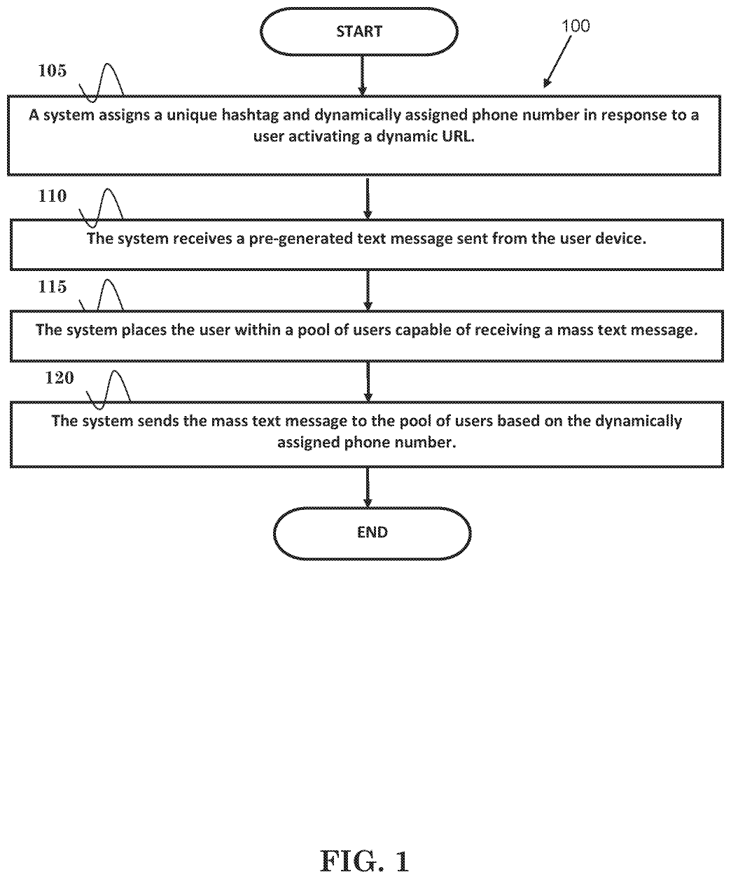

FIG. 1 illustrates one exemplary method 100 of sending mass text messages. In step 105, a system assigns a unique hashtag and dynamically assigned phone number in response to a user activating a dynamic URL. In step 110, the system receives a pre-generated text message sent from the user device. In step 115, the system places the user within a pool of users capable of receiving a mass text message. In step 120, the system sends the mass text message to the pool of users based on the dynamically assigned phone number.

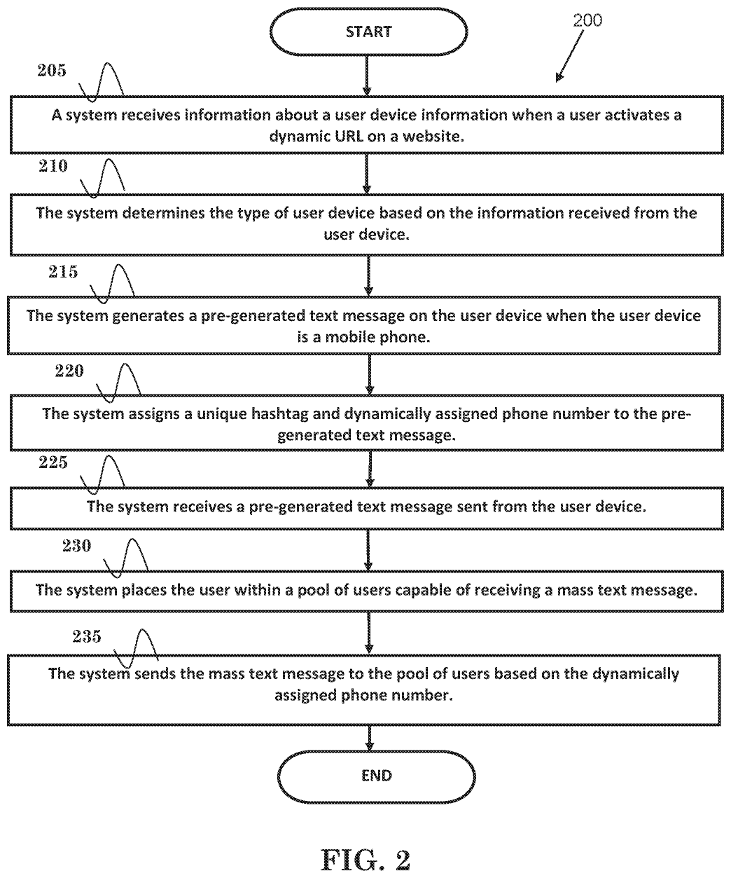

FIG. 2 illustrates one exemplary method 200 of sending mass text messages. In step 205, a system receives information about a user device information when a user activates a dynamic URL on a website. In step 210, the system determines the type of user device based on the information received from the user device. In step 215, the system generates a pre-generated text message on the user device when the user device is a mobile phone. In step 220, the system assigns a unique hashtag and dynamically assigned phone number to the pre-generated text message. In step 225, system receives a pre-generated text message sent from the user device. In step 230, the system places the user within a pool of users capable of receiving a mass text message. In step 235, the system sends the mass text message to the pool of users based on the dynamically assigned phone number.

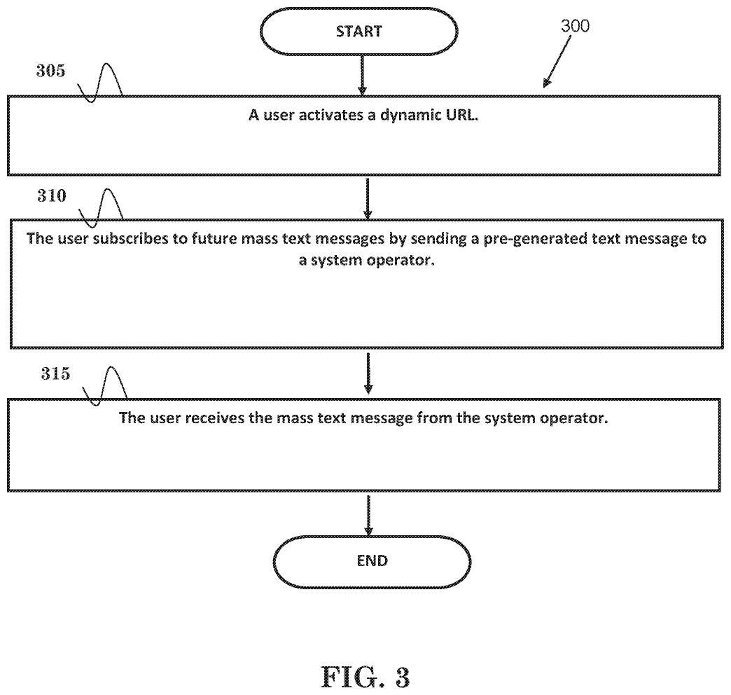

FIG. 3 illustrates one exemplary method 300 of enrolling and receiving a mass text message. In step 305, a user activates a dynamic URL. In step 310, the user subscribes to future mass text messages by sending a pre-generated text message to a system operator. In step 315, the user received the mass text message from the system operator.

Although an embodiment has been described with reference to specific example embodiments, it will be evident that various modifications and changes may be made to these embodiments without departing from the scope of the present disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Description, therefore, is not to be taken in a limiting sense, and the scope of various embodiments is defined only by the appended claims, along with the full range of equivalents to which such claims are entitled.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field-programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. Those skilled in the art will appreciate that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network and via one or more appropriate interfaces (e.g., application programming interfaces (APIs)).

Example embodiments may be implemented in digital electronic circuitry, in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special-purpose logic circuitry (e.g., an FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

In one example, a computer system within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, a network switch, a network bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system includes a processor (e.g., a central processing unit (CPU), a graphics processing unit (GPU), or both), a main memory, and a static memory, which communicate with each other via a bus. The computer system may further include a video display unit (e.g., a liquid crystal display (LCD) or a cathode ray tube (CRT)). The computer system also includes an alphanumeric input device (e.g., a keyboard), a user interface (UI) navigation (or cursor control) device (e.g., a mouse), a disk drive unit, a signal generation device (e.g., a speaker), and a network interface device.

The disk drive unit includes a machine-readable medium on which is stored one or more sets of data structures and instructions (e.g., software) embodying or utilized by any one or more of the methodologies or functions described herein. The instructions may also reside, completely or at least partially, within the main memory and/or within the processor during execution thereof by the computer system, the main memory and the processor also constituting machine-readable media. The instructions may also reside, completely or at least partially, within the static memory.

While the machine-readable medium is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding, or carrying instructions for execution by the machine and that cause the machine to perform any one or more of the methodologies of the present embodiments, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., erasable programmable read-only memory (EPROM), electrically erasable programmable read-only memory (EEPROM), and flash memory devices); magnetic disks such as internal hard disks and removable disks; magneto-optical disks; and compact disc-read-only memory (CD-ROM) and digital versatile disc (or digital video disc) read-only memory (DVDROM) disks.

The instructions may further be transmitted or received over a communication network using a transmission medium. The instructions may be transmitted using the network interface device and any one of a number of well-known transfer protocols (e.g., hypertext transfer protocol (HTTP)). Examples of communication networks include a local-area network (LAN), a wide-area network (WAN), the Internet, mobile telephone networks, plain old telephone service (POTS) networks, and wireless data networks (e.g., Wi-Fi and WiMax networks). The term “transmission medium” shall be taken to include any intangible medium capable of storing, encoding, or carrying instructions for execution by the machine, and includes digital or analog communications signals or other intangible media to facilitate communication of such software.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

While the invention has been described in connection with various aspects, it will be understood that the embodiments disclosed herein are capable of further modifications. This application is intended to cover any variations, uses or adaptation of the invention following, in general, the principles of the invention, and including such departures from the present disclosure as come within the known and customary practice within the art to which the invention pertains.

1. A method for sending mass text messages, the method comprising:
assigning a unique hashtag and dynamically assigned phone number in response to a user activating a dynamic URL;
receiving a pre-generated text message sent from the user device;
placing the user within a pool of users capable of receiving a mass text message; and
sending the mass text message to the pool of users based on the dynamically assigned phone number.

2. The method of claim 1, further comprising:
determining a type of the user device based on the information received from the user activation of the dynamic URL.

3. The method of claim 2, further comprising:
generating a pre-generated text message on the user device when the user device is a mobile phone.

4. The method of claim 1, further comprising:
selecting a pool of users to receive a mass text message.

5. A method for sending mass text messages, the method comprising:
receiving information about a user device information when a user activates a dynamic URL on a website;
determining a type of the user device based on the information received from the user device;
generating a pre-generated text message on the user device when the user device is a mobile phone;
assigning a unique hashtag and dynamically assigned phone number to the pre-generated text message;
receiving the pre-generated text message sent from the user device;
placing the user within a pool of users capable of receiving a mass text message; and
sending the mass text message to the pool of users based on the dynamically assigned phone number.

6. The method of claim 5, further comprising:
selecting a pool of users to receive a mass text message.

7. A system for sending mass text messages, the system comprising:
a processor; and
a memory coupled to the processor, wherein the processor is configured to execute a program code stored in the memory to:
assign a unique hashtag and dynamically assigned phone number in response to a user activating a dynamic URL;
receive a pre-generated text message sent from the user device;
place the user within a pool of users capable of receiving a mass text message;
select a pool of users to receive a mass text message; and
send the mass text message to the pool of users based on the dynamically assigned phone number.

8. The system of claim 7 further comprising program code to:
receive information about a user device information when a user activates a dynamic URL.

9. The system of claim 7 further comprising program code to:
determine a type of the user device based on the information received from the user device.

10. The system of claim 7 further comprising program code to:
create and present a pre-generated text message on the user device when the user device is a mobile phone.

11. The system of claim 7 further comprising program code to:
create and present a pre-generated email address on the user device when the user device is not associated with a phone number.

12. The system of claim 7, wherein the dynamic URL is in the form of a QR code.
